(19) United States
(12) Patent Application Publication
(10) Pub. No.: US 2014/0278933 A1
(43) Pub. Date: Sep. 18, 2014

(54) METHODS AND APPARATUS TO MEASURE AUDIENCE ENGAGEMENT WITH MEDIA

(71) Applicant: F. Gavin McMillan, Tarpon Springs, FL (US)

(72) Inventor: F. Gavin McMillan, Tarpon Springs, FL (US)

(21) Appl. No.: 13/841,047

(22) Filed: Mar. 15, 2013

(51) Int. Cl. G10L 15/08; G06Q 30/02

(52) U.S. Cl. CPC G10L 15/08; G06Q 30/0246
USPC 705/14.45; 704/254

(57) ABSTRACT

Methods, apparatus, systems and articles of manufacture are disclosed to measure audience engagement with media. An example method for measuring audience engagement with media presented in an environment is disclosed herein. The method includes identifying the media presented by a presentation device in the environment, and obtaining a keyword list associated with the media. The method also includes analyzing audio data captured in the environment for an utterance corresponding to a keyword of the keyword list, and incrementing an engagement counter when the utterance is detected.

### FIELD OF THE DISCLOSURE

This disclosure relates generally to audience measurement and, more particularly, to methods and apparatus to measure audience engagement with media.

### BACKGROUND

Audience measurement of media (e.g., broadcast television and/or radio, stored audio and/or video content played back from a memory such as a digital video recorder or a digital video disc, a webpage, audio and/or video media presented (e.g., streamed) via the Internet, a video game, etc.) often involves collection of media identifying data (e.g., signature(s), fingerprint(s), code(s), tuned channel identification information, time of exposure information, etc.) and people data (e.g., user identifiers, demographic data associated with audience members, etc.). The media identifying data and the people data can be combined to generate, for example, media exposure data indicative of amount(s) and/or type(s) of people that were exposed to specific piece(s) of media.

In some audience measurement systems, the people data is collected by capturing a series of images of a media exposure environment (e.g., a television room, a family room, a living room, a bar, a restaurant, etc.) and analyzing the images to determine, for example, an identity of one or more persons present in the media exposure environment, an amount of people present in the media exposure environment during one or more times and/or periods of time, etc. The collected people data can be correlated with media identifying information corresponding to media detected as being presented in the media exposure environment to provide exposure data (e.g., ratings data) for that media.

### BRIEF DESCRIPTION OF THE DRAWINGS

FIG. 1 is an illustration of an example meter constructed in accordance with teachings of this disclosure in an example environment of use.

FIG. 2 is a block diagram of an example implementation of the example meter of FIG. 1.

FIG. 3 is a block diagram of an example implementation of the example engagement tracker of FIG. 2

FIG. 4 illustrates an example data structure maintained by the example engagement tracker of FIGS. 2 and/or 3.

FIG. 5 is a flowchart representative of example machine readable instructions that may be executed to implement the example meter of FIGS. 1 and/or 2.

FIG. 6 is a flowchart representative of example machine readable instructions that may be executed to implement the example engagement tracker of FIGS. 2 and/or 3.

FIG. 7 is a flowchart representative of example machine readable instructions that may be executed to implement the audience measurement facility of FIG. 1.

FIG. 8 is a block diagram of an example processor platform capable of executing the example machine readable instructions of FIGS. 5 and/or 6 to implement the example engagement tracker of FIGS. 2 and/or 3.

### DETAILED DESCRIPTION

In some audience measurement systems, people data is collected for a media exposure environment (e.g., a television room, a family room, a living room, a bar, a restaurant, an office space, a cafeteria, etc.) by capturing audio data in the media exposure environment and analyzing the audio data to determine, for example, levels of attentiveness of one or more persons in the media exposure environment, an identity of one or more persons present in the media exposure environment, an amount of people present in the media exposure environment during one or more times and/or periods of time, etc. The people data can be correlated with media identifying information corresponding to detected media to provide exposure and/or ratings data for that media. For example, an audience measurement entity (e.g., The Nielsen Company (US), LLC) can calculate ratings for a first piece of media (e.g., a television program) by correlating data collected from a plurality of panelist sites with the demographics of the panelists at those sites. For example, for each panelist site at which the first piece of media is detected at a first time, media identifying information for the first piece of media is correlated with presence information detected in the media exposure environment at the first time. In some examples, the results from multiple panelist sites are combined and/or analyzed to provide ratings representative of exposure of a population as a whole.

Example methods, apparatus, and/or articles of manufacture disclosed herein non-invasively measure audience engagement with media presented in a media exposure environment (e.g., a television room, a family room, a living room, a bar, a restaurant, an office space, a cafeteria, etc.). In particular, examples disclosed herein capture audio data associated with a media exposure environment and analyze the audio data to detect spoken words or utterances corresponding to one or more keyword(s) associated with a particular piece of media (e.g., a particular advertisement or program) that is currently being presented to an audience. As described in detail below, examples disclosed herein recognize the utterance(s) of the keyword(s) associated with the currently presented piece of media as indicative of audience engagement with that piece of media. To obtain an example measurement of engagement or attentiveness, examples disclosed herein count a number of keyword detections (e.g., instances of an audience member speaking a word) for pieces of media. As used herein, recognizable keywords are keywords that have a dictionary definition and/or correspond to a name.

Engagement levels disclosed herein provide information regarding attentiveness of audience member(s) to, for example, particular portions or events of media, such as a particular scene, an appearance of a particular actor or actress, a particular song being played, a particular product being shown, etc. As described below, examples disclosed herein utilize timestamps associated with the detected keyword utterances and timing information associated with the media to align the engagement measurements with particular portions of the media. Thus, engagement levels disclosed herein are indicative of, for example, how attentive audience member(s) become and/or remain when a particular person, brand, or object is present in the media, and/or when a particular event or type of event occurs in media. In some examples disclosed herein, engagement levels of separate audience members (who may be physically located at a same specific exposure environment and/or at multiple different exposure environments) are combined, aggregated, statistically adjusted, and/or extrapolated to formulate a collective engagement level for an audience at one or more physical locations.

Examples disclosed herein recognize that listening for keywords associated with every possible piece of media is difficult, if not impractical. To enable a practical, efficient, and cost-effective keyword detection mechanism, examples disclosed herein utilize specific dictionaries (e.g., sets or lists of keywords) generated for particular pieces of media. In some examples, the lists of keywords associated with respective pieces of media are provided to examples disclosed herein by audience measurement entities and/or advertisers. For example, if an advertiser elects to create an advertisement promoting the advertiser and/or its products, the advertiser may provide a corresponding list of keywords (e.g., dictionary) associated with the advertisement. The list of keywords (e.g., dictionary) provided by the advertiser is specific for an advertisement, the advertiser, the advertised product, etc. The advertiser selects the keywords for inclusion in the list based on, for example, which words stand out based on the displayed or spoken content of the advertisement. Additionally or alternatively, the audience measurement entity may generate a keyword list. For example, the audience measurement entity may create a keyword engagement database based on one or more advertisements for an advertiser(s). In some examples, the audience measurement entity may supplement their keyword engagement database with the list provided by the advertiser. In some examples, certain advertisements may evoke specific expected reactions from audience members and the corresponding keyword list is generated according to the expected reactions (e.g., utterances). Keywords can be selected on additional or alternative bases and/or in additional or alternative manners. Further, in some examples, keyword lists disclosed herein are generated by additional or alternative entities, such as a manager and/or provider of an audience measurement system.

Examples disclosed herein have access to the keyword lists and retrieve an appropriate one of the keyword lists in response to, for example, a corresponding piece of media being detected in the monitored environment. For example, when a particular program is detected in the monitored environment (e.g., via detection of a signature, via detection of a watermark, via detection of a code, via a table lookup correlating media to channels and/or to times, etc.), examples disclosed herein retrieve the corresponding keyword list and begin listening for the keywords of the retrieved list. In some examples disclosed herein, each detection of one of the keywords of the retrieved list increments a count for the keyword and/or the detected piece of media. In some such instances, the count is considered a measurement of engagement of the audience. Further, in some examples, the audio data captured while listening to the monitored environment is discarded, leaving only the count(s) of detected keywords. Thus, examples disclosed herein provide increased privacy for the audience by maintaining keyword count(s) rather than storing entire conversations.

FIG. 1 illustrates an example environment 100 in which examples disclosed herein to measure audience engagement with media may be implemented. The example environment 100 of FIG. 1 includes an example media provider 105, an example monitored environment 110, an example communication network 115, and an example audience measurement facility (AMF) 120. The example media provider 105 may be, for example, a cable provider, a radio signal provider, a satellite provider, an Internet source, etc. In some examples, the media is provided to the monitored environment 110 via a distribution network such as an internet-based media distribution network (e.g., video and/or audio media), a terrestrial television and/or radio distribution network (e.g., over-the-air, etc.), a satellite television and/or radio distribution network, physical medium based media distribution network (e.g., media distributed on a compact disc, a digital versatile disk, a Blu-ray disc, etc.), or any other type of or combination of distribution networks.

In the illustrated example of FIG. 1, the monitored environment 110 is a room of a household (e.g., a room in a home of a panelist such as the home of a “Nielsen family”) that has been statistically selected to develop television ratings data for a geographic location, a market and/or a population/demographic of interest. In the illustrated example, one or more persons of the household have registered with an audience measurement entity (e.g., by agreeing to be a panelist) and have provided their demographic information to the audience measurement entity as part of a registration process to enable associating demographics with viewing activities (e.g., media exposure). In the illustrated example of FIG. 1, the monitored environment 110 includes one or more example information presentation devices 125, an example set-top box (STB) 130, an example multimodal sensor 140 and an example meter 135. In some examples, an audience measurement entity provides the multimodal sensor 140 to the household. In some examples, the multimodal sensor 140 is a component of a media presentation system purchased by the household such as, for example, a component of a video game system (e.g., Microsoft® Kinect®) and/or piece(s) of equipment associated with a video game system (e.g., a Kinect® sensor). In some such examples, the multimodal sensor 140 may be repurposed and/or data collected by the multimodal sensor 140 may be repurposed for audience measurement.

In the illustrated example of FIG. 1, the multimodal sensor 140 is positioned in the monitored environment 110 at a position for capturing audio and/or image data of the monitored environment 110. In some examples, the multimodal sensor 140 is integrated with a video game system. For example, the multimodal sensor 140 may collect audio data using one or more sensors for use with the video game system and/or may also collect such audio data for use by the meter 135. In some examples, the multimodal sensor 140 employs an audio sensor to detect audio data in the monitored environment 110. For example, the multimodal sensor 140 of FIG. 1 includes a microphone and/or a microphone array.

In the example of FIG. 1, the meter 135 is a software meter provided for collecting and/or analyzing data from, for example, the multimodal sensor 140 and/or other media identification data collected as explained below. In some examples, the meter 135 is installed in, for example, a video game system (e.g., by being downloaded to the same from a network, by being installed at the time of manufacture, by being installed via a port (e.g., a universal serial bus (USB) from a jump drive provided by the audience measurement entity, by being installed from a storage disc (e.g., an optical disc such as a Blu-ray disc, Digital Versatile Disc (DVD) or CD (compact Disk)), or by some other installation approach). Executing the meter 135 on the panelist's equipment is advantageous in that it reduces the costs of installation by relieving the audience measurement entity of the need to supply hardware to the monitored household). In other examples, rather than installing the software meter 135 on the panelist's consumer electronics, the meter 135 is a dedicated audience measurement unit provided by the audience measurement entity. In some such examples, the meter 135 may include its own housing, processor, memory and software to perform the desired audience measurement functions. In some such examples, the meter 135 is adapted to communicate with the multimodal sensor 140 via a wired or wireless connection. In some such examples, the communications are affected via the panelist's consumer electronics (e.g., via a video game console). In other example, the multimodal sensor 140 is dedicated to audience measurement and, thus, the consumer electronics owned by the panelist are not utilized for the monitoring functions.

The example monitored environment 110 of FIG. 1 can be implemented in additional and/or alternative types of environments such as, for example, a room in a non-statistically selected household, a theater, a restaurant, a tavern, a store, an arena, etc. For example, the environment may not be associated with a panelist of an audience measurement study, but instead may simply be an environment associated with a purchased XBOX® and/or Kinect® system. In some examples, the example monitored environment 110 of FIG. 1 is implemented, at least in part, in connection with additional and/or alternative types of information presentation devices such as, for example, a radio, a computer, a tablet, a cellular telephone, and/or any other communication device able to present media to one or more individuals.

In the illustrated example of FIG. 1, the information presentation device 125 (e.g., a television) is coupled to a set-top box (STB) 130 that implements a digital video recorder (DVR) and/or a digital versatile disc (DVD) player. Alternatively, the DVR and/or DVD player may be separate from the STB 130. In some examples, the meter 135 of FIG. 1 is installed (e.g., downloaded to and executed on) and/or otherwise integrated with the STB 130. Moreover, the example meter 135 of FIG. 1 can be implemented in connection with additional and/or alternative types of media presentation devices such as, for example, a radio, a computer display, a video game console and/or any other communication device able to present content to one or more individuals via any past, present or future device(s), medium(s), and/or protocol(s) (e.g., broadcast television, analog television, digital television, satellite broadcast, Internet, cable, etc.).

As described in detail below in connection with FIG. 2, the example meter 135 of FIG. 1 also monitors the monitored environment 110 to identify media being presented (e.g., displayed, played, etc.) by the information presentation device 125 and/or other media presentation devices to which the audience is exposed (e.g., a personal computer, a tablet, a smartphone, a laptop computer, etc.). As described in detail below, identification(s) of media to which the audience is exposed is utilized to retrieve a list of keywords associated with the media, which the example meter 135 of FIG. 1 uses to measure audience engagement levels with the identified media.

In the illustrated example of FIG. 1, the meter 135 periodically and/or aperiodically exports data (e.g., audience engagement levels, media identification information, audience identification information, etc.) to the audience measurement facility (AMF) 120 via the communication network 115. The example communication network 115 of FIG. 1 is implemented using any suitable wired and/or wireless network(s) including, for example, data buses, a local-area network, a wide-area network, a metropolitan-area network, the Internet, a digital subscriber line (DSL) network, a cable network, a power line network, a wireless communication network, a wireless mobile phone network, a Wi-Fi network, etc. As used herein, the phrase “in communication,” including variations thereof, encompasses (1) direct communication and/or (2) indirect communication through one or more intermediary components, and, thus, does not require direct physical (e.g., wired) connection. In the illustrated example of FIG. 1, the AMF 120 is managed and/or owned by an audience measurement entity (e.g., The Nielsen Company (US), LLC).

Additionally or alternatively, analysis of the data generated by the example meter 135 may be performed locally (e.g., by the example meter 135) and exported via the communication network 115 to the AMF 120 for further processing. For example, the number of keyword detections as counted by the example meter 135 in the monitored environment 110 at a time in which a sporting event was presented by the information presentation device 125 can be used in an engagement calculation for the sporting event. The example AMF 120 of the illustrated example compiles data from a plurality of monitored environments (e.g., other households, sports arenas, bars, restaurants, amusement parks, transportation environments, retail locations, etc.) and analyzes the data to measure engagement levels for a piece of media, temporal segments of the data, geographic areas, demographic sets of interest, etc.

FIG. 2 is a block diagram of an example implementation of the example meter 135 of FIG. 1. The example meter 135 of FIG. 2 includes an audience detector 200 to develop audience composition information regarding, for example, audience members of the example monitored environment 110 of FIG. 1. The example meter 135 of FIG. 2 includes a media detector 205 to collect media information regarding, for example, media presented in the monitored environment 110 of FIG. 1. The example multimodal sensor 140 of FIG. 2 includes a directional microphone array capable of detecting audio in certain patterns or directions in the monitored environment 110. In some examples, the multimodal sensor 140 is implemented at least in part by a Microsoft® Kinect® sensor.

In some examples, the example multimodal sensor 140 of FIG. 2 implements an image capturing device, such as a camera and/or depth sensor, that captures image data representative of the monitored environment 110. In some examples, the image capturing device includes an infrared imager and/or a charge coupled device (CCD) camera. In some examples, the multimodal sensor 140 only captures data when the information presentation device 125 is in an “on” state and/or when the media detector 205 determines that media is being presented in the monitored environment 110 of FIG. 1. The example multimodal sensor 140 of FIG. 2 may also include one or more additional sensors to capture additional and/or alternative types of data associated with the monitored environment 110.

The example audience detector 200 of FIG. 2 includes a people analyzer 210, an engagement tracker 215, a time stamper 220, and a memory 225. In the illustrated example of FIG. 2, data obtained by the multimodal sensor 140, such as audio data and/or image data is stored in the memory 225, time stamped by the time stamper 220 and made available to the people analyzer 210. The example people analyzer 210 of FIG. 2 generates a people count or tally representative of a number of people in the monitored environment 110 for a frame of captured image data. The rate at which the example people analyzer 210 generates people counts is configurable. In the illustrated example of FIG. 2, the example people analyzer 210 instructs the example multimodal sensor 140 to capture audio data and/or image data representative of the environment 110 in real time (e.g., virtually simultaneously with) as the information presentation device 125 presents the particular media. However, the example people analyzer 210 can receive and/or analyze data at any suitable rate.

The example people analyzer 210 of FIG. 2 determines how many people appear in a frame (e.g., video frame) in any suitable manner using any suitable technique. For example, the people analyzer 210 of FIG. 2 recognizes a general shape of a human body and/or a human body part, such as a head and/or torso. Additionally or alternatively, the example people analyzer 210 of FIG. 2 may count a number of “blobs” that appear in the frame and count each distinct blob as a person. Recognizing human shapes and counting “blobs” are illustrative examples and the people analyzer 210 of FIG. 2 can count people using any number of additional and/or alternative techniques. An example manner of counting people is described by Ramaswamy et al. in U.S. patent application Ser. No. 10/538,483, filed on Dec. 11, 2002, now U.S. Pat. No. 7,203,338, which is hereby incorporated herein by reference in its entirety. In some examples, to determine the number of detected people in a room, the example people analyzer 210 of FIG. 2 also tracks a position (e.g., an X-Y coordinate) of each detected person.

Additionally, the example people analyzer 210 of FIG. 2 executes a facial recognition procedure such that people captured in the frames can be individually identified. In some examples, the audience detector 200 utilizes additional or alternative methods, techniques and/or components to identify people in the frames. For example, the audience detector 200 of FIG. 2 can implement a feedback system to which the members of the audience provide (e.g., actively) identification information to the meter 135. To identify people in the frames, the example people analyzer 210 of FIG. 2 includes or has access to a collection (e.g., stored in a database) of facial signatures (e.g., image vectors). Each facial signature of the illustrated example corresponds to a person having a known identity to the people analyzer 210. The collection includes a facial identifier for each known facial signature that corresponds to a known person. For example, the collection of facial signatures may correspond to frequent visitors and/or members of the household associated with the example environment 110 of FIG. 1. The example people analyzer 210 of FIG. 2 analyzes one or more regions of a frame thought to correspond to a human face and develops a pattern or map for the region(s) (e.g., using depth data provided by the multimodal sensor 140). The pattern or map of the region represents a facial signature of the detected human face. In some examples, the pattern or map is mathematically represented by one or more vectors. The example people analyzer 210 of FIG. 2 compares the detected facial signature to entries of the facial signature collection. When a match is found, the example people analyzer 210 has successfully identified at least one person in the frame. In some such examples, the example people analyzer 210 of FIG. 2 records (e.g., in a memory 225 accessible to the people analyzer 210) the facial identifier associated with the matching facial signature of the collection. When a match is not found, the example people analyzer 210 of FIG. 2 retries the comparison or prompts the audience for information that can be added to the collection of known facial signatures for the unmatched face. More than one signature may correspond to the same face (i.e., the face of the same person). For example, a person may have one facial signature when wearing glasses and another when not wearing glasses. A person may have one facial signature with a beard, and another when cleanly shaven.

In some examples, each entry of the collection of known people used by the example people analyzer 210 of FIG. 2 also includes a type for the corresponding known person. For example, the entries of the collection may indicate that a first known person is a child of a certain age and/or age range and that a second known person is an adult of a certain age and/or age range. In instances in which the example people analyzer 210 of FIG. 2 is unable to determine a specific identity of a detected person, the example people analyzer 210 of FIG. 2 estimates a type for the unrecognized person(s) detected in the monitored environment 110. For example, the people analyzer 210 of FIG. 2 estimates that a first unrecognized person is a child, that a second unrecognized person is an adult, and that a third unrecognized person is a teenager. The example people analyzer 210 of FIG. 2 bases these estimations on any suitable factor(s) such as, for example, height, head size, body proportion(s), etc.

Although the illustrated example uses image recognition to attempt to recognize audience members, some examples do not attempt to recognize the audience members. Instead, audience members are periodically or aperiodically prompted to self-identify. U.S. Pat. No. 7,203,338 discussed above is an example of such a system.

In the illustrated example, data obtained by the multimodal sensor 140 of FIG. 2 is also made available to the engagement tracker 215. As described in greater detail below in connection with FIG. 3, the example engagement tracker 215 of FIG. 2 measures and/or generates engagement level(s) for media presented in the monitored environment 110.

The example people analyzer 210 of FIG. 2 outputs the calculated tallies, identification information, person type estimations for unrecognized person(s), and/or corresponding image frames to the time stamper 220. Similarly, the example engagement tracker 215 outputs data (e.g., calculated behavior(s), engagement levels, media selections, etc.) to the time stamper 220. The time stamper 220 of the illustrated example includes a clock and/or a calendar. The example time stamper 220 associates a time period (e.g., 1:00 a.m. Central Standard Time (CST) to 1:01 a.m. CST) and date (e.g., Jan. 1, 2013) with each calculated people count, identifier, video or image frame, behavior, engagement level, media selection, audio segment, code, signature, etc., by, for example, appending the period of time and data information to an end of the data. A data package including the timestamp and the data (e.g., the people count, the identifier(s), the engagement levels, the behavior, the image data, audio segment, code, signature, etc.) is stored in the memory 225.

The memory 225 may include a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The memory 225 may include one or more double data rate (DDR) memories, such as DDR, DDR2, DDR3, mobile DDR (mDDR), etc. The memory 225 may additionally or alternatively include one or more mass storage devices such as, for example, hard drive disk(s), compact disk drive(s), digital versatile disk drive(s), etc. When the example meter 135 is integrated into, for example a video game system, the meter 135 may utilize memory of the video game system to store information such as, for example, the people counts, the image data, the engagement levels, etc.

The example time stamper 220 of FIG. 2 also timestamps data obtained by example media detector 205. The example media detector 205 of FIG. 2 detects presentation(s) of media in the monitored environment 110 and/or collects media identification information associated with the detected presentation(s). For example, the media detector 205, which may be in wired and/or wireless communication with the information presentation device (e.g., television) 125, the multimodal sensor 140, the STB 130, and/or any other component(s) (e.g., a video game system) of a monitored environment system, can obtain media identification information and/or a source of a presentation. The media identifying information and/or the source identification data may be utilized to identify the program by, for example, cross-referencing a program guide configured, for example, as a look up table. In such instances, the source identification data may be, for example, the identity of a channel (e.g., obtained by monitoring a tuner of the STB 130 of FIG. 1 or a digital selection made via a remote control signal) currently being presented on the information presentation device 125. In some such examples, the time of detection as recorded by the time stamper 220 is employed to facilitate the identification of the media by cross-referencing a program table indicating broadcast media by time of broadcast.

Additionally or alternatively, the example media detector 205 can identify the presentation by detecting codes (e.g., watermarks) embedded with or otherwise conveyed (e.g., broadcast) with media being presented via the STB 130 and/or the information presentation device 125. As used herein, a code is an identifier that is transmitted with the media for the purpose of identifying and/or for tuning to (e.g., via a packet identifier header and/or other data used to tune or select packets in a multiplexed stream of packets) the corresponding media. Codes may be carried in the audio, in the video, in metadata, in a vertical blanking interval, in a program guide, in content data, or in any other portion of the media and/or the signal carrying the media. In the illustrated example, the media detector 205 extracts the codes from the media. In some examples, the media detector 205 may collect samples of the media and export the samples to a remote site for detection of the code(s).

Additionally or alternatively, the media detector 205 can collect a signature representative of a portion of the media. As used herein, a signature is a representation of some characteristic of signal(s) carrying or representing one or more aspects of the media (e.g., a frequency spectrum of an audio signal). Signatures may be thought of as fingerprints of the media. Collected signature(s) can be compared against a collection of reference signatures of known media to identify the tuned media. In some examples, the signature(s) are generated by the media detector 205. Additionally or alternatively, the media detector 205 may collect samples of the media and export the samples to a remote site for generation of the signature(s). In the example of FIG. 2, irrespective of the manner in which the media of the presentation is identified (e.g., based on tuning data, metadata, codes, watermarks, and/or signatures), the media identification information and/or the source identification information is time stamped by the time stamper 220 and stored in the memory 225. In the illustrated example, the media identification information is also sent to the engagement tracker 215.

In the illustrated example of FIG. 2, the output device 230 periodically and/or aperiodically exports data (e.g., media identification information, audience identification information, etc.) from the memory 225 to a data collection facility (e.g., the example audience measurement facility 120 of FIG. 1) via a network (e.g., the example connection network 115 of FIG. 1).

While an example manner of implementing the meter 135 of FIG. 1 is illustrated in FIG. 2, one or more of the elements, processes and/or devices illustrated in FIG. 2 may be combined, divided, re-arranged, omitted, eliminated and/or implemented in any other way. Further, the example audience detector 200, the example media detector 205, the example people analyzer 210, the example engagement tracker 215, the example time stamper 220 and/or, more generally, the example meter 135 of FIG. 2 may be implemented by hardware, software, firmware and/or any combination of hardware, software and/or firmware. Thus, for example, any of the example audience detector 200, the example media detector 205, the example people analyzer 210, the example engagement tracker 215, the example time stamper 220 and/or, more generally, the example meter 135 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example audience detector 200, the example media detector 205, the example people analyzer 210, the example engagement tracker 215, the example time stamper 220 and/or, more generally, the example meter 135 are hereby expressly defined to include a tangible computer readable storage device or storage disc such as a memory, DVD, CD, Blu-ray, etc. storing the software and/or firmware. Further still, the example meter 135 of FIG. 1 may include one or more elements, processes and/or devices in addition to, or instead of, those illustrated in FIG. 2, and/or may include more than one of any or all of the illustrated elements, processes and devices.

FIG. 3 is a block diagram of an example implementation of the example engagement tracker 215 of FIG. 2. As described above in connection with FIG. 2, the example engagement tracker 215 of FIG. 3 accesses (e.g., receives) data collected by the multimodal sensor 140 and the media detector 205. The example engagement tracker 215 of FIG. 3 processes and/or interprets the data provided by the multimodal sensor 140 and the media detector 205 to analyze one or more aspects of behavior (e.g., engagement) exhibited by one or more members of an audience. In particular, the example engagement tracker 215 of FIG. 2 uses identifiers for pieces of media (e.g., media identification information) provided by the media detector 205 and audio data detected by the multimodal sensor 140 to generate an attentiveness metric (e.g., engagement level) for each piece of detected media presented in the monitored environment 110 (e.g., by a media presentation device, such as the information presentation device 125 of FIG. 1). In the illustrated example, the engagement level calculated by the engagement tracker 215 is indicative of how attentive the audience member(s) are to a corresponding piece of media.

In the illustrated example of FIG. 3, the engagement tracker 215 includes a keyword list database 305 from which a list selector 310 is to retrieve one of a plurality of keyword lists 315 associated with the piece of media detected by the media detector 205 as being currently presented. The example keyword list database 305 of FIG. 3 receives and stores lists of keywords associated with media from any suitable source. For example, the example meter 135 includes a communication interface to enable the meter 135 to communicate over a network, such as the example communication network 115 of FIG. 1. As such, the keyword list database 305 of FIG. 3 receives the keyword lists 315 from any suitable source (e.g., an advertiser, an audience measurement entity, a content provider, a broadcaster, a third party associated with an advertiser, from a data channel provided with the media, etc.) via any desired distribution mechanism (e.g., over the Internet, via a satellite connection, via cable access to a cable service provider, etc.). In the illustrated example of FIG. 3, the example keyword list database 305 of FIG. 3 stores the keyword lists 315 locally such that the lists 315 can be quickly retrieved for utilization by a keyword detector 320. In some examples, the keyword list database 305 is periodically (e.g., every 24 hours, etc.) and/or aperiodically (e.g., event-driven such as when a media identifier in modified, etc.) updated (e.g., via instructions received from a server over the example communication network 115). In some examples, the keyword list database 305 is separate from, but local to, the example engagement tracker 215 (e.g., in communication with the list selector 310 via local interfaces such as a Universal Serial Bus (USB), FireWire, Small Computer System Interface (SCSI), etc.).

In the illustrated example of FIG. 3, the list selector 310 uses a media identifier provided by media detector 205 to locate the keyword list 315 associated with the detected piece of media. That is, the example list selector 310 of FIG. 3 is triggered to retrieve one of the keyword lists 315 for analysis by the keyword detector 320 from the keyword list database 305 in response to media identification information received from the media detector 205. In some examples, the list selector 310 may use a lookup table to select the appropriate one of keyword lists 315 from the keyword list database 305. Additional or alternative methods to retrieve a list of one or more keyword(s) associated with a piece of media may be used. An example keyword list 315 selected by the example list selector 310 of FIG. 3 from the keyword list database 305 is described below in connection with FIG. 4.

Additionally or alternatively, the list selector 310 of FIG. 3 may retrieve a plurality of keyword lists 315 associated with a detected piece of media. For example, an advertiser may produce an advertising campaign including three related commercials (e.g., media A, B and C). In such examples, receiving media identification information from the media detector 205 for piece of media A may trigger the example list selector 310 to retrieve a respective keyword list 315 for each of the related pieces of media A, B and C, and aggregate the respective keywords into a larger keyword list 315 for analysis by the keyword detector 320 of FIG. 3.

In the illustrated example of FIG. 3, the keyword detector 320 compares audio information collected by the multimodal sensor 140 to the selected one of the keyword lists 315 provided by the list selector 310. The example keyword detector 320 of FIG. 3 uses, for example, audio information provided by a microphone array of the multimodal sensor 140. In the illustrated example of FIG. 3, the keyword detector 320 compares the one or more keyword(s) included in the selected keyword list 315 to the spoken words detected in the audio data provided by the multimodal sensor 140. In the illustrated example of FIG. 3, the keyword detector 320 utilizes any suitable speech recognition system(s) to detect when one or more of the keyword(s) included in the selected keyword list 315 are spoken by an audience member in the monitored environment 110. A keyword detected by the example keyword detector 320 is referred to herein as an “engaged” word. Because the example keyword detector 320 of FIG. 3 uses a relatively small set of particular keywords (e.g., the one or more keyword(s) included in the selected keyword list/dictionary 315), the example meter 135 of FIGS. 1 and/or 2 may be implemented while using less processor resources than, for example, speech recognizers that are tasked with using relatively large vocabulary sets.

In some examples, the keyword detector 320 analyzes the audio data provided by the multimodal sensor 140 until a change event (e.g., trigger) is detected. For example, the media detector 205 may indicate that new media is being presented (e.g., a channel change event). In some examples, the keyword detector 320 may cease analyzing the current keyword list based on the indication from the media detector 205. In some examples, the keyword detector 320 includes a timer and/or communicates with a timer. In some such examples, the keyword detector 320 analyzes the audio data provided by the multimodal sensor 140 for keywords included in the selected keyword list 315 for a predetermined period of time (e.g., five minutes after the currently presented media is identified). In some examples, the keyword detector 320 buffers (e.g., temporarily stores) the audio data provided by the multimodal sensor 140 while analyzing the audio data (when the particular piece of media is identified) for utterances that match words included in the selected keyword list 315. For example, the keyword detector 320 may buffer audio data collected by the multimodal sensor 140 for five minutes when an advertisement is identified. As a result, when, for example, a conversation continues after a media change (e.g., a channel change event, a new piece of media begins, etc.), utterances of keywords associated with the previous media can still be detected by the keyword detector 320. In some examples, the keyword detector 320 deletes (or clears) the buffered audio data after the audio data has been analyzed by the keyword detector 320 and/or a trigger is detected. As a result, audio data (e.g., a conversation) is not stored or accessible at a later time (e.g., by an audience measurement entity), and audience privacy is maintained.

In some examples, the keyword detector 320 filters the audio data prior to analyzing the audio data for utterances. For example, the keyword detector 320 may subtract an audio waveform representative of the piece of media (e.g., media audio) from the audio data provided by the multimodal sensor 140. As a result, the residual (or filtered) audio data represents audience member speech rather than spoken words included in the currently presented piece of media. In such examples, the keyword detector 320 scans the residual signal for utterances of keywords of the selected keyword list 315.

In the illustrated example of FIG. 3, a keyword logger 325 credits, tallies and/or logs engaged words associated with the detected piece of media based on indications received from the keyword detector 320. In the illustrated example, the keyword detector 320 sends a message to the keyword logger 325 instructing the keyword logger 325 to increment a specific counter 325a, 325b, or 325n of a corresponding keyword for a corresponding piece of media. In the example keyword logger 325, each of the counters 325a, 325b, 325n is dedicated to one of the keywords of the selected keyword list 315. The example message generated by the example keyword detector 320 references the counter to be incremented in any suitable fashion (e.g., by sending an address of the counter, by sending a keyword identifier and media identification information). Alternatively, the keyword detector 320 may simply list the engaged word in a data structure or it may tabulate all the engaged words in a single data structure with corresponding memory addresses of the counters to be incremented for each corresponding keyword. In some examples, the keyword logger 325 appends and/or prepends additional information to the crediting data. For instance, the example keyword logger 325 of FIG. 3 appends a timestamp indicating the date and/or time the example meter 135 detected the corresponding keyword. In some examples, the keyword logger 325 periodically (e.g., after expiration of a predetermined period) and/or aperiodically (e.g., in response to one or more predetermined events such as whenever a predetermined engagement tally is reached, etc.) communicates the aggregate engagement counts for each keyword and/or detected piece of media to the audience measurement facility (AMF) 120 of FIG. 1. That is, the example keyword logger 325 of FIG. 3 communicates individual counts for each keyword in the selected keyword list 315 and/or a total count for the particular piece of media (e.g., a sum of the individual counts) to the AMF 120. Thus, the AMF 120 may use the aggregate engagement counts to track total engagement and/or frequency of engagement for each keyword associated with the piece of media and/or each piece of media.

In some examples, a particular piece of media may include (e.g., spoken or displayed) keywords included in the selected keyword list 315. For example, an advertisement for a product may include a person saying the name of the product (e.g., “Ford Fusion”). To prevent false crediting of engaged words (e.g., increasing an engagement tally for a corresponding keyword said in the particular piece of media), the example engagement tracker 215 of FIG. 3 includes an example offset filter 330. In the illustrated example, the offset filter 330 uses offset information included in the keyword lists 315 to determine whether a keyword detection is due to the keyword being used in the piece of media rather than being said by the audience. In the illustrated example, the offset information indicates if and/or when the keyword(s) is included (e.g., spoken and/or displayed) during presentation of an identified piece of media. In some examples, the offset information identifies when (e.g., a time offset) a keyword is spoken in a piece of media. In some such examples, when the offset filter 330 of FIG. 3 determines the timestamp of the crediting data (e.g., via the example keyword logger 325) matches the time offset(s) of the spoken word, the offset filter 330 negates the keyword detection. For example, the offset filter 330 may cancel (or negate) the keyword detection message sent from the keyword detector 320, decrease the engagement tally for the corresponding keyword in the keyword logger 325, etc. In some examples, the offset information identifies the number of times a keyword is included in the piece of media. In some such examples, the offset filter 330 of FIG. 3 may subtract the number from the engagement tally in the example keyword logger 325 each time the piece of media is detected (e.g., by the example media detector 205 of FIG. 2).

FIG. 4 illustrates an example data structure 400 that maps keywords 405 included in a selected keyword list 400 associated with a piece of media (e.g., the example keyword list 315 of FIG. 3) with a corresponding engagement tally 410. In FIG. 4, an example piece of media 415 (e.g., “Fusion Commercial #1”) includes a keyword entry 420 for a keyword “Ford” with a corresponding engagement tally of 16.

In the illustrated example, some keyword entries also include one or more offsets 425. For example, a keyword entry 430 for the word “hybrid” includes no offset information as that word is not audibly output by the media while the keyword entry 420 for the word “Ford” includes one offset (e.g., the time offset “00:49.3”) as that term is audibly spoken 49.3 seconds into the media. As described above in connection with FIG. 3, the example offset filter 330 uses the offset information 425 to prevent false crediting of engaged words. For example, if the keyword detector 320 detects “Ford” at the 00:49.3 mark during the presentation of the advertisement 415 (e.g., the “Fusion Commercial #1”), the example offset filter 330 negates the keyword detection message sent from the keyword detector 320 to the keyword logger 325 to prevent an increment in the engagement tally 410 of the keyword entry 420.

Although the illustrated example utilizes specific keywords for specific media, in some examples, a universal set of keywords are used. The universal set of keywords may be intended to identify sentiment as opposed to correlating with the subject matter of the content of the media. Example keywords for such universal sets of keywords include awesome, terrible, great, beautiful, cool, and disgusting. In some instances, utterances of keywords such as these indicate a strong positive or strong negative reaction to the media. In some examples, tallies generated based on such utterances are used to analyze user reactions such that future media can be tailored to obtain more positive responses from audience members. For example, an actor that produces strong negative feedback might be eliminated from a future television show or future commercial.

While an example manner of implementing the engagement tracker 215 of FIG. 2 is illustrated in FIG. 3, one or more of the elements, processes and/or devices illustrated in FIG. 3 may be combined, divided, re-arranged, omitted, eliminated and/or implemented in any other way. Further, the example list selector 310, the example keyword detector 320, the example keyword logger 325, the example offset filter 330, and/or, more generally, the example engagement tracker 215 of FIG. 3 may be implemented by hardware, software, firmware and/or any combination of hardware, software and/or firmware. Thus, for example, any of the example list selector 310, the example keyword detector 320, the example keyword logger 325, the example offset filter 330, and/or, more generally, the example engagement tracker 215 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example list selector 310, the example keyword detector 320, the example keyword logger 325, the example offset filter 330, and/or more generally, the example engagement tracker 215 are hereby expressly defined to include a tangible computer readable storage device or storage disc such as a memory, DVD, CD, Blu-ray, etc. storing the software and/or firmware. Further still, the example engagement tracker 215 of FIG. 2 may include one or more elements, processes and/or devices in addition to, or instead of, those illustrated in FIG. 3, and/or may include more than one of any or all of the illustrated elements, processes and devices.

A flowchart representative of example machine readable instructions for implementing the meter 135 of FIGS. 1 and/or 2 is shown in FIG. 5. A flowchart representative of example machine readable instructions for implementing the engagement tracker 215 of FIGS. 2 and/or 3 is shown in FIG. 6. A flowchart representative of example machine readable instructions for implementing the AMF 120 of FIG. 1 is shown in FIG. 7. In these examples, the machine readable instructions comprise program(s) for execution by a processor such as the processor 812 shown in the example processor platform 800 discussed below in connection with FIG. 8. The program(s) may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program(s) are described with reference to the flowcharts illustrated in FIGS. 5-7, many other methods of implementing the example meter 135, the example engagement tracker 215 and/or the example AMF 120 may alternatively be used. For example, the order of execution of the blocks may be changed, and/or some of the blocks described may be changed, eliminated, or combined.

As mentioned above, the example processes of FIGS. 5-7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 5-7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

The program of FIG. 5 begins at block 500 with an initiation of the example meter 135 of FIGS. 1 and/or 2. At block 505, the example media detector 205 monitors the example monitored environment 110 for media from, for example, the example information presentation device 125. If a particular piece of media is not detected by the media detector 205 (block 510), control returns to block 505 to continue to monitor the monitored environment 110 for media. If a particular piece of media is detected by the example media detector 205 (block 510), control proceeds to block 515. At block 515, the example engagement tracker 215 (FIG. 2) is triggered and media identification information corresponding to the detected piece of media is provided to the engagement tracker 215.

At block 520, the example meter 125 provides audio collected in the example monitored environment 110 to the engagement tracker 215. For example, the multimodal sensor 140 may provide audio data including media audio from the example information presentation device 125 and spoken audio from audience member(s) in the monitored environment 110. As described in greater detail below in connection with FIG. 6, at block 525, the example meter 125 receives a tally generated by the example engagement tracker 215. The tally corresponds to a number of keyword detections detected in the audio data. At block 530, the example meter 135 associates the tally with the detected piece of media. For example, a data package including timestamp provided by the example time stamper 220 and data (e.g., the people count, the media identification information, the identifier(s), the engagement levels, the keyword tallies, the behavior, the image data, audio segment, code, signature, etc.) is stored in the memory 225. At block 535, the example output device 230 conveys the data to the example audience measurement facility 120 for additional processing. Control returns to block 505.

The program of FIG. 6 begins at block 600 at which the example engagement tracker 215 (FIG. 3) of the example meter 120 (FIG. 1) is trigger. At block 605, the example engagement tracker 215 receives media identification information for a piece of media presented in a media exposure environment. For example, the example media detector 205 (FIG. 2) detects an embedded watermark in media presented in the monitored environment 110 (FIG. 1) by the information presentation device 125 (FIG. 1), and identifies the piece of media using the embedded watermark. (e.g., by querying a database at the AMF 120 in real time, querying a local database, etc.). The example media detector 205 then sends the media identification information to the example engagement tracker 215.

At block 610, the example list selector 310 obtains one of the keyword lists 315 of the keyword list database 305 (FIG. 3) associated with the media identification information. For example, the example list selector 310 (FIG. 3) looks up a keyword list 315 including one or more keyword(s) associated with the detected piece of media using the media identification information provided by the media detector 205.

At block 615, the example engagement tracker 215 analyzes audio data captured in the monitored environment using the selected keyword list 315. For example, the keyword detector 320 uses a speech recognition system or algorithm to analyze the audio data captured by the multimodal sensor 140 (FIG. 1) for utterances of one or more of the keyword(s) (e.g., recognizable keywords) included in the selected keyword list 315.

If a keyword from the selected keyword list 315 is not detected by the keyword detector 320 (block 620), control proceeds to block 635 and a determination is made whether the end of the detected media (e.g., the audio data) is detected.

Otherwise, if a keyword from the selected keyword list 315 is detected by the keyword detector 320 (block 620), control proceeds to block 625. At block 625, the example engagement tracker 215 determines whether to increment a tally associated with the detected keyword. For example, the example offset filter 330 (FIG. 3) compares a keyword timestamp corresponding to when the keyword was detected with a time offset included in the keyword list. If there is a match between the keyword timestamp and a corresponding time offset for the detected keyword, control proceeds to block 635.

In contrast, if the offset filter 330 does not identify a match between the keyword timestamp and a corresponding time offset for the detected keyword (block 625), control proceeds to block 630. At block 630, the example engagement tracker 215 credits the detected word in the list of keywords. For example, the keyword logger 325 records an entry when crediting (or logging) an engaged word with a detection.

At block 635, the example engagement tracker 215 determines whether a trigger is detected. For example, the keyword detector 320 may analyze the audio data provided by the multimodal sensor 140 until the media detector 205 indicates new media is being presented, until a timer expires (e.g., for a predetermined period), etc. If the example keyword detector 320 does not detect a trigger (block 635), control returns to block 615. If the example keyword detector 320 detects a trigger (block 635), such as a timer expiring, the example keyword logger 325 provides the keyword tally information to the example time stamper 220 (FIG. 2). Control then returns to a calling function or process, such as the example program 500 of FIG. 5, and the example process of FIG. 6 ends.

The program of FIG. 7 begins at block 705 at which the example audience measurement facility (AMF) 120 (FIG. 1) receives keyword detection information generated by the example engagement tracker 215 (FIG. 2) of the example meter 135 (FIG. 1) in a monitored environment 110 (FIG. 1). For example, the meter 135 communicates (periodically, aperiodically, etc.) keyword detection information to the AMF 120.

At block 710, the example AMF 120 generates audience engagement metrics based on a tally of keyword detection(s) for a particular media. The audience engagement metrics may be generated in any desired (or suitable) fashion. For example, the AMF 120 generates audience engagement metrics based on tallied keyword detections as disclosed herein. In some examples, the AMF 120 sums the number of tallies according to timestamps appended to the crediting data. In such examples, a comparison of the number of tallies during different timestamp ranges indicates the attentiveness of audience members throughout the day. For example, certain keywords may be detected more frequently during the early morning hours than during afternoon hours. Thus, it may be beneficial for a purveyor of goods or services that caters to early morning audience members to present their media during those hours.

In some examples, at block 710, the example AMF 120 sums the number of tallies according to, for example, related media in an advertising campaign. For example, the total number of keyword detections for the media included in the advertising campaign is summed. In some such examples, a comparison of the total numbers across previous adverting campaigns may be used to determine the effectiveness of certain advertising campaigns over others. For example, the effectiveness of an advertising campaign may be determined based on a comparison of the number of keyword detections tallied from the advertising campaign divided by the number of dollars spent on the advertising campaign. This data may be further analyzed to determine, for example, which pieces of media were more effective relative to the amount of money paid to present the piece of media.

At block 715 of FIG. 7, the example AMF 120 generates a report based on the audience engagement metric. In some examples, the AMF 120 may associate the results with other known audience monitoring information. For example, the AMF 120 may correlate demographic information with the engagement information received from the example meter 135. The example process 700 of FIG. 7 then ends.

FIG. 8 is a block diagram of an example processor platform 800 capable of executing the instructions of FIGS. 5-7 to implement the example meter 135 of FIGS. 1 and/or 2, the example engagement tracker 215 of FIGS. 2 and/or 3 and/or the example AMF 120 of FIG. 1. The processor platform 800 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 5, 6 and/or 7 may be stored in the mass storage device 828, in the volatile memory 814, in the non-volatile memory 816, and/or on a removable tangible computer readable storage medium such as a CD or DVD.

From the foregoing, it will appreciate that methods, apparatus and articles of manufacture have been disclosed which measure audience engagement with media presented in a monitored environment, while maintaining audience member privacy.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of measuring audience engagement with media presented in an environment, the method comprising:
identifying the media presented by a presentation device in the environment;
obtaining a keyword list associated with the media;
analyzing audio data captured in the environment for an utterance corresponding to a keyword of the keyword list; and
incrementing an engagement counter when the utterance is detected.

2. A method as defined in claim 1, further comprising discarding the audio data after analyzing the audio data.

3. A method as defined in claim 1, further comprising buffering the audio data when an advertisement is detected in the audio data.

4. A method as defined in claim 1, wherein the keyword list comprises a plurality of keywords, each keyword is associated with a respective engagement counter, and further comprising timestamping a respective one of the engagement counters when a corresponding utterance is detected.

5. A method as defined in claim 4, further comprising:
comparing the timestamp of a first one of the engagement counters to offset information included in the list; and
decrementing the engagement counter if the timestamp matches the offset information.

6. A method as defined in claim 1, further comprising generating a report based on a value in the engagement counter.

7. A method as defined in claim 1, wherein analyzing the audio data further comprises:
using a multimodal sensor to capture the audio data, the audio data including media audio from a presentation device and spoken audio from a panelist;
subtracting an audio waveform corresponding to the media audio from the spoken audio to generate a residual signal; and
scanning the residual signal for the keyword of the keyword list.

8. An apparatus to measure audience engagement with media comprising:
a list selector to obtain a keyword list based on media detected as being presented in an environment, wherein the keyword list is to comprise a plurality of keywords and each keyword is associated with a respective engagement counter;
a keyword detector to detect a keyword of the keyword list in audio data collected in the environment; and
a keyword logger to increment a respective one of the engagement counters when an utterance detected in the audio data matches the corresponding keyword.

9. An apparatus as defined in claim 8, wherein the keyword detector is to discard the audio data after analyzing the audio data.

10. An apparatus as defined in claim 8, wherein the keyword detector is to buffer the audio data when the media is identified.

11. An apparatus as defined in claim 8, wherein the keyword logger is to append a timestamp a respective one of the engagement counters when a corresponding utterance is detected.

12. An apparatus as defined in claim 11, further comprising an offset filter to decrement the engagement counter if the timestamp of a first one of the engagement counters matches the offset information associated with the keyword corresponding to the engagement counter.

13. An apparatus as defined in claim 8, wherein the keyword logger is to generate a report based on a value in the engagement counter.

14. An apparatus as defined in claim 8, wherein the keyword detector is to subtract an audio waveform corresponding to the identified media from the audio data to generate a residual signal, wherein the audio data is to include media audio and spoken audio, and the keyword detector is to scan the residual signal for the keyword of the keyword list.

15. A tangible computer readable storage medium comprising instructions that, when executed, cause a machine to at least:
identify media presented in an environment by a presentation device;
obtain a keyword list associated with the identified media, wherein the keyword list is to comprise a plurality of keywords, and each keyword is associated with a respective engagement counter;
analyze audio data captured in the environment for an utterance to correspond to a keyword of the keyword list, the audio data to include media audio and spoken audio; and
increment a respective one of the engagement counters when the utterance is detected.

16. A tangible computer readable storage medium as defined in claim 15, the instructions to cause the machine to discard the audio data after a trigger is detected.

17. A tangible computer readable storage medium as defined in claim 15, the instructions to cause the machine to buffer the audio data when the media is identified.

18. A tangible computer readable storage medium as defined in claim 15, the instructions to cause the machine to append a timestamp to a respective one of the engagement counters when a corresponding utterance is detected.

19. A tangible computer readable storage medium as defined in claim 18, the instructions to cause the machine to:
compare the timestamp of a first one of the engagement counters to offset information included in the keyword list, the offset information associated with the detected keyword; and
decrement the engagement counter if the timestamp matches the offset information.

20. A tangible computer readable storage medium as defined in claim 15, the instructions to cause the machine to generate a report based on a value in the engagement counter.
